(19) United States
(12) Patent Application Publication
(10) Pub. No.: US 2006/0167745 A1
(43) Pub. Date: Jul. 27, 2006

(54) Providing low-cost message display boards

(76) Inventor: Paul Wiethorn, Centennial, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/040,411

(22) Filed: Jan. 21, 2005

(51) Int. Cl. G07G 1/14; G06F 17/00; G06Q 30/00; G06F 3/00

(52) U.S. Cl. 705/14; 715/752

(57) ABSTRACT

Embodiments of the present invention relate to providing low-cost message display boards to users of a message display board service. According to one embodiment of the present invention, display boards capable of displaying a user designated message are supplied by a provider of a message display board service for free or for a very low cost. The user may then use the display board to display personalized messages designated by the user. In exchange for use of the low-cost or no-cost display board, the user accepts that the display board is adapted to receive periodic, supervening messages from the service provider that will be temporarily displayed on the display board in place of any user designated message. The supervening messages transmitted by the service provider may be advertising messages supplied by the service provider or one or more third party advertisers who pay a fee to the service provider in exchange for the display of the ads on display boards of the users.

### TECHNICAL FIELD

The invention relates generally to the field of message display boards or signs. More particularly, the invention relates to providing a message display board or sign at low cost or no cost to the end user in exchange for allowing the provider of the message display board to display supervening messages.

### BACKGROUND OF THE INVENTION

Advertisers use a wide range of media to reach potential customers or clients. Among these media are a number of different types electronic display boards capable of displaying messages. For example, Light Emitting Diode (LED) signs made up of a matrix of individual LEDs are widely available. An advertiser or other user can program such a sign to scroll, flash, or otherwise display a message on such a display board. Other similar media may be used in place of an LED display board. For example, such a display board may be in the form of a Cathode Ray Tube (CRT), Liquid Crystal Display (LCD), or other type of display.

However, such equipment can be expensive. For a large business or advertiser, such cost may not be a problem but for a small business, the cost of the equipment may be prohibitive. Further, individuals may find such display boards useful for various personal, individual applications. However, the individual, like the small business, may find the cost of the equipment to be too high and therefore not practical. It is with respect to these considerations and others that the present invention has been made.

### SUMMARY OF THE INVENTION

Embodiments of the present invention relate to providing low-cost message display boards to users of a message display board service. According to one embodiment of the present invention, display boards capable of displaying a user designated message are supplied by a provider of a message display board service for free or for a very low cost. The user may place the display board in various locations, either at his choosing or within limitations specified by the service provider. The user may then use the display board to display personalized messages designated by the user. In exchange for use of the low-cost or no-cost display board, the user accepts that the display board is adapted to receive periodic, supervening messages from the service provider that will be temporarily displayed on the display board in place of any user designated message. The supervening messages transmitted by the service provider may be advertising messages or other types of messages supplied by the service provider or one or more third party advertisers who pay a fee to the service provider in exchange for the display of the ads on display boards of the users. Such fees create a revenue stream for the service provider which can defray the costs of the display board equipment supplied to the users, thereby allowing the service provider to provide the equipment at little or no cost to the user.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIGS. 1A and 1B illustrate one possible application of a message display board according to one embodiment of the present invention.

FIGS. 2A and 2B illustrate another possible application of a message display board according to one embodiment of the present invention.

FIG. 3 illustrates at a high level major components of a system for providing low-cost message display boards according to one embodiment of the present invention.

FIG. 4 is a block diagram conceptually illustrating sending messages to users of a message board service according to one embodiment of the present invention.

FIG. 5 is a block diagram illustrating a service provider system for providing messages to users of a message board system according to one embodiment of the present invention.

FIG. 6 is a flowchart illustrating sending messages to users of a message board system according to one embodiment of the present invention.

FIG. 7 is a block diagram illustrating a user system for displaying user designated messages and supervening, service provider originated messages according to one embodiment of the present invention.

FIG. 8 is a flowchart illustrating displaying user designated messages and supervening, service provider originated messages according to one embodiment of the present invention.

### DETAILED DESCRIPTION OF THE INVENTION

Embodiments of the present invention relate to providing low-cost message display boards to users of a message display board service. According to one embodiment of the present invention, display boards capable of displaying a user designated message are supplied by a provider of a message display board service for free or for a very low cost. The user may place the display board in various locations, either at his choosing or within limitations specified by the service provider. The user may then use the display board to display personalized messages designated by the user. In exchange for use of the low-cost or no-cost display board, the user accepts that the display board is adapted to receive periodic, supervening messages from the service provider that will be temporarily displayed on the display board in place of any user designated message. The supervening messages transmitted by the service provider may be advertising messages supplied by the service provider or one or more third party advertisers who pay a fee to the service provider in exchange for the display of the ads on display boards of the users. Such fees create a revenue stream for the service provider which can defray the costs of the display board equipment supplied to the users, thereby allowing the service provider to provide the equipment at little or no cost to the user.

A display board, provided by a message display board service may be placed or used in a variety of applications or environments in which a user wishes to display personalized messages and/or the service provider or its advertisers wish to place advertisement messages. For example, a message display board provided by a service provider may be placed in or on motor vehicles, billboards, commercial buildings, homes, or other public or private property or venues. The placement of the display board may be limited by agreement between the service provider and the user to only locations which the service provider approves. Further, the messages displayed on the display board by the user may be limited to prevent display of vulgar or obscene messages. As will be discussed in detail below, such limitations may be implemented in hardware, firmware, or software controlling the display board.

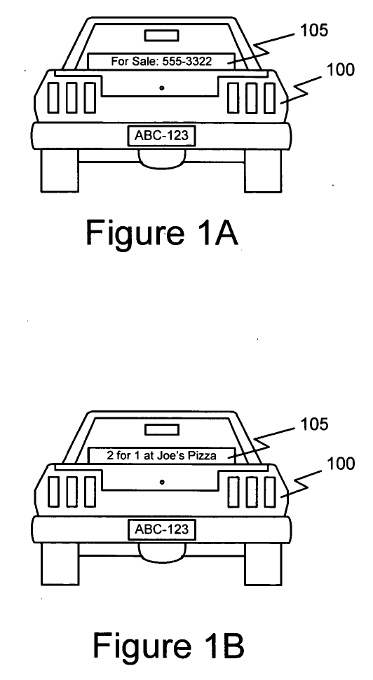

FIGS. 1A and 1B illustrate one possible application of a message display board according to one embodiment of the present invention. In this embodiment, a display board 105 provided by a message display board service provider is shown mounted in the rear window of a private automobile 100. In FIG. 1A, the display board 105 is being used by the user, in this case the owner of the vehicle 100, to display a personal message. Here the message indicates that the vehicle 100 is for sale. Other messages which the user may wish to display in such a situation may include messages to other drivers such as: “Your lights are off”; “Your turn signal is on”; “Traffic ahead”; “You're hot call me 555-1122”; etc. As will be discussed further below, such messages may be preprogrammed into controls for the display board by either the service provider or the user and may be selectable by the user. Alternatively, the messages may be entered by the user via a keyboard, touch pad, other input device, or even via voice recognition software. In addition to text, other types of messages may be displayed. For example, a message may include graphics, video, animations, or other visual or audio-visual indication or representation.

In FIG. 1B, the user designated message has been replaced by a supervening message sent from the service provider to the user system. This message is now displayed on the display board 105. That is, the user designated message, if any, is temporarily replaced on the display board 105 with the message sent from the service provider. The supervening message may be commercial in nature. For example, the message may be an advertisement for one or more third party advertisers who pay a fee to the service provider for display of the ad on display boards of the users. In some cases, the supervening messages may be advertisements for the service provider.

According to one embodiment of the present invention, if no message is designated by the user, a default message may be displayed on the display board or the display board may be left blank. The default message, if any, may be preprogrammed by the service provider or the user or, for a display board used in motor vehicles, may be related to the operation of the vehicle. For example, controls for the display board may be coupled with the vehicle and display messages such as “STOP” or “TURNING RIGHT” or “TURNING LEFT” when the brakes or turn signals are actuated.

Therefore, a priority scheme may be implemented by controls for the display board as will be discussed in detail below. Basically, such a priority scheme may comprise giving top priority to all messages sent from the service provider and lowest priority to any default messages with user designated messages having a middle priority. However, exceptions are possible. For example, if a message board used in a vehicle is adapted to display messages related to operation of the vehicle, such messages may take priority over user designated messages or even service provider messages.

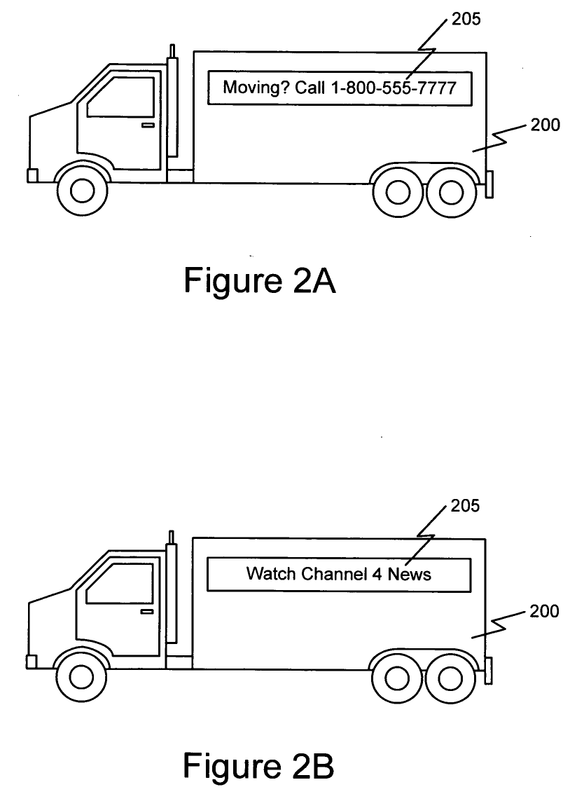

FIGS. 2A and 2B illustrate another possible application of a message board according to one embodiment of the present invention. In this example, the display board 205 is mounted on a commercial vehicle 200. In such a case, the user of the message display board service may be the owner or operator of the commercial vehicle 200. FIG. 2A shows the display board 205 displaying a user designated message in the form of an advertisement for the owner or operator of the commercial vehicle. FIG. 2B shows the user designated message being replaced with a supervening service provider message that is now displayed on the display board 205.

Depending upon the use or location of the display board, different agreements may be made between the service provider and the user. For example, a user who agrees to use the display board for personal purposes, such as in a private motor vehicle 100 shown in FIGS. 1A and 1B, may be provided with the display board for free while a user using the display board for commercial purposes, such as the commercial vehicle 200 in FIGS. 2A and 2B, may be required to pay an equipment lease fee to the service provider. Further, this lease fee may be determined based on a number of criteria. For example, the lease fee may depend upon the type, number, frequency, and/or duration of supervening service provider messages to be displayed. Further, the priority level given to the different types of messages may depend upon the agreement between the user and the service provider with fees for the service dependent upon the priority given to the service provider messages. For example, a first fee level, which may be free, may require the user to accept all service provider messages at the highest priority with all other messages at a lower priority. Other, higher fee levels may be specified by the service provider to low for lowering the priority given to service provider messages.

Since the number, type, frequency, duration, etc. of the supervening service provider messages may vary between users, not all messages sent from the service provide are uniform between all users. While some messages may be broadcast to all users, other messages may be intended for only particular users. Therefore, as will be discussed below, the messages may be addressable to particular users or may contain header information to allow the controls of the display board of the individual user to distinguish which messages are intended for that particular display board.

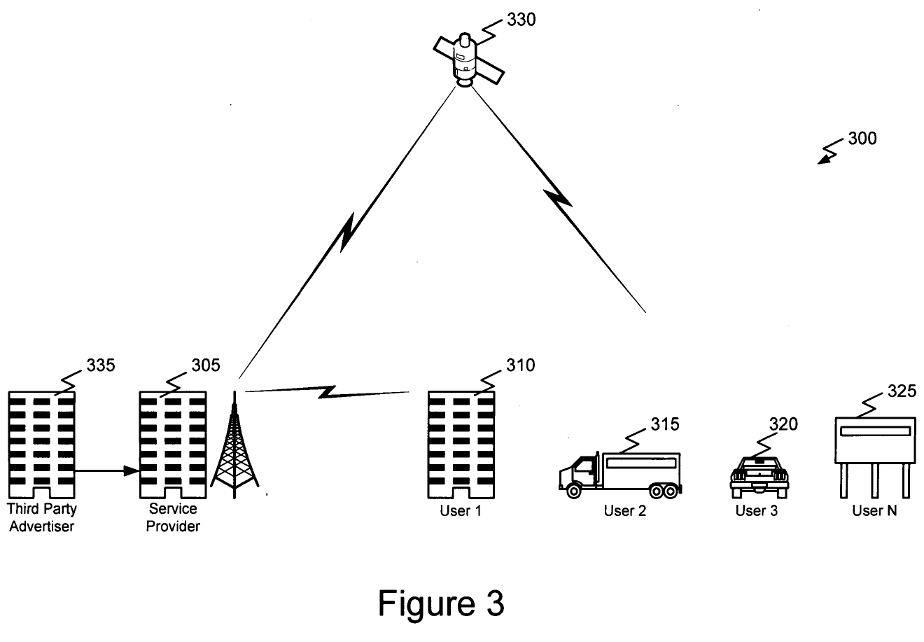

FIG. 3 illustrates at a high level major components of a system for providing low-cost message display boards according to one embodiment of the present invention. This system 300 includes a message display board service provider 305 and a number of users 310-325. FIG. 3 also shows a third party advertiser 335. Of course more than one third party advertiser 335 may exist in other implementations.

Generally speaking, the service provider 305 provides display board systems, including all appropriate controls and peripherals for operating the display boards, to the users 310-325. As noted above and illustrated here, the users 310-325 can use the display boards in various applications or environments in which users wish to display personalized messages and/or the service provider or its advertisers wish to place advertisement messages. In some cases, the service provider may place limits, via a service agreement, on where and how the display boards are placed and used.

As explained above, the users 310-325 may then use the display boards to display a variety of personal, preprogrammed, or default messages selected by the user or displayed by default or based on the operation of the vehicle. As noted above, the type of messages displayed by the users may be limited by the controls of the display board to prevent display of vulgar or obscene messages.

The service provider 305 can receive from the third party advertiser 335 requests for advertising messages or an actual message to be displayed on one or more of the display boards of the users 310-325. Alternatively, the service provider 305 may generate messages to be displayed. These messages are then transmitted to the users 310-325 via a transmission media. As shown here, the transmission media can include satellite 330 or over-the-air type transmissions of various types including but not limited to AM, FM, cellular telephone, pager, microwave, VHF, UHF, shortwave, or other types of terrestrial network.

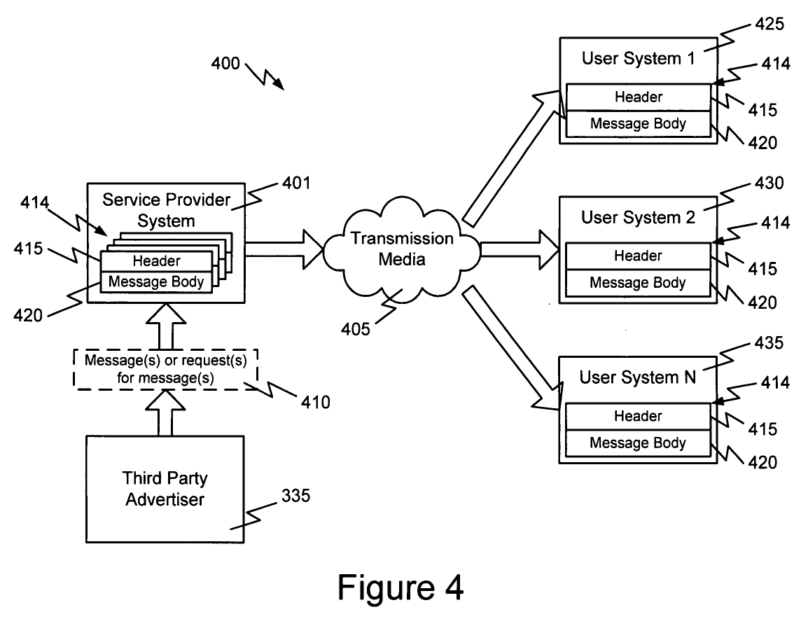

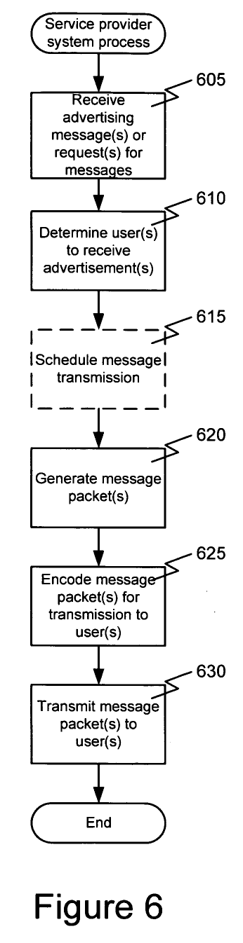

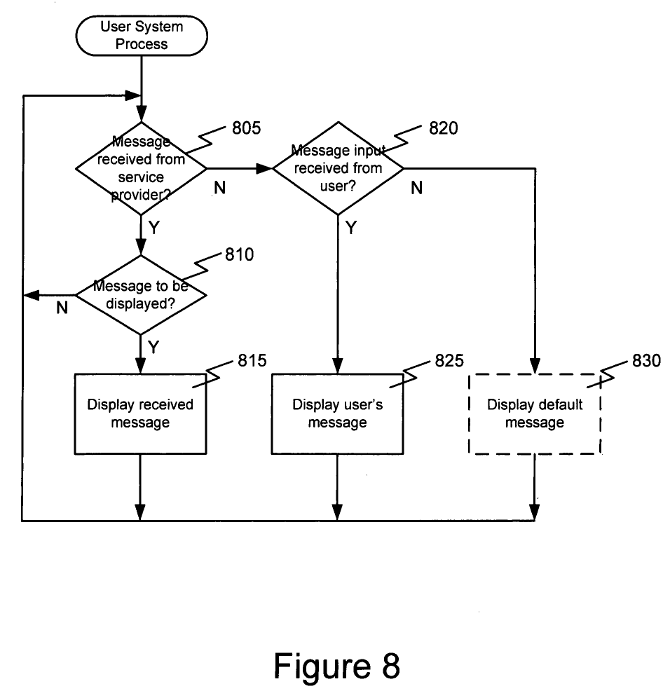

FIG. 4 is a block diagram conceptually illustrating sending messages to users of a message board service according to one embodiment of the present invention. Here, the system 400 is shown to include a service provider system 401, and a number of user systems 425-435. As noted above, each user receives from the service provider a display board and associated controls and peripherals that together comprise the user system. Details of a user system and the functions performed therein will be discussed further below with reference to FIGS. 6 and 8.

The service provider system 401 receives from one or more third party advertisers 335 messages or requests for messages 410 to be displayed on the display boards of one or more user systems 425-435. According to one embodiment of the present invention, the service provider system 401 may then generate one or more message packets 414 each comprising a header 415 and a message body 420. As noted above, not all messages may be intended for display on all user systems. Therefore, the header 415 of each message packet 414 is used to identify the user system 424-435 for which the message packet 414 is intended. The information in the header 415 may indicate an address, such as an Internet Protocol (IP) address, or other identifying information to indicate to which user system 425-435 the message packet 414 is being transmitted. Alternatively, the header 415 may include other information identifying the content of the message, message type, user group, or other information that can be used by the individual user systems 425-435 to determine which of the message packets 414 should be displayed by that system and which should be ignored. For example, the head may include text or other data such as commercial, private, mobile, or some other group name or number, indicating a subgroup or subclass of users for which the message packet 414 is being addressed.

According to an alternative embodiment of the present invention, no header is generated. In such a case, each message packet includes the message body but no header. Such message packets, when transmitted from the service provider system will be received and processed by all user systems within range of the transmission. In the case that a terrestrial network is used for the transmission media, the subscribers that receive the message may be related to a geographic region or area. For example, if a pager or cell phone network is used to transmit the service provider messages, the users that receive the message can be limited by the number of cells used to transmit the message. Therefore, only users within range of those cells will receive and display the message.

In summary, the service provider system 401 receives messages or requests for messages from the third party advertiser 335 and generates and/or encodes one or more message packets 414 based on the third party advertiser's 335 message or request. These message packets 414 are then transmitted via a transmission media 405 to the user systems 425-435. As noted above, the transmission media 405 may be any of a variety of possible media such as satellite or over-the-air terrestrial network transmissions of various types including but not limited to AM, FM, cellular telephone, pager, microwave, VHF, UHF, shortwave, or other types of media.

Each user system 425-435 receives the one or more message packets 414 from the transmission media 405 and decodes each message packet 414 to determine, based on the header 415 information, if any, of each message packet 414, whether the message packet 414 is intended for that user system 425-435. If the message packet 414 is intended for that user system 425-435, the message data from the message body 420 can be displayed on the display board of the user system 425-435, preempting any default or user designated message currently being displayed. This message may be displayed for a predetermined period of time programmed in the memory of the user system. Alternatively, the amount of time may be indicated as a field of data within the header 415 of the message packet 414.

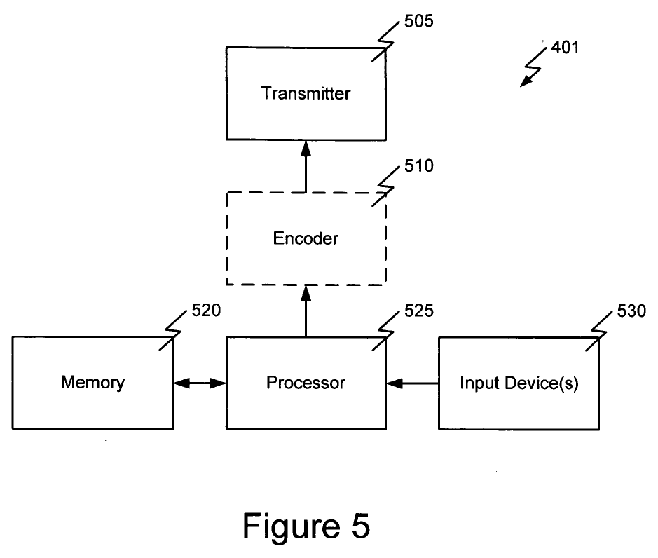

FIG. 5 is a block diagram illustrating a service provider system for providing messages to users of a message board system according to one embodiment of the present invention. In this example, the service provider system 401 comprises a processor 525 coupled with memory 520, one or more input devices 530, and an encoder 510. The encoder 510 is also coupled with a transmitter 505. The processor runs programs, an example of which will be described in more detail below with reference to FIG. 6, that enable the service provider system 401 to perform the tasks described thus far. Such programs may be stored in memory 520. Memory 520 may comprise a primary or secondary memory such as Random Access Memory (RAM), Read-Only Memory (ROM), Erasable Programmable Read-Only Memory (EPROM), flash memory or other memory technology, CD-ROM, Digital Versatile Disks (DVD) or other optical storage, magnetic cassettes, magnetic tape, magnetic disk storage or other magnetic storage devices, or any other medium that can be used to store the desired information and that can be accessed by the processor 525 and may be located external to or within the service provider system. Memory 520 may also be internal to processor 525 in some embodiments.

Processor 525 receives input representing messages or requests for messages to be sent to one or more user systems from one or more input devices 530. Input devices 530 may comprise any of a wide variety of possible devices such as commonly used to provide input to computer systems. For example, input devices contemplated as suitable for use include but are not limited to keyboard, mouse, pen, voice input device, touch input device, etc. Through such an input device 530, one or more third party advertisers or operators of the service provider system 401 may submit messages or requests for messages to be sent to one or more users. According to one embodiment of the present invention, input device 530 may comprise a network connection coupled with the Internet or some other Local Area Network (LAN) or Wide Area Network (WAN). Through such a network, one or more third party advertisers may submit messages or requests for messages to be sent to one or more users. The request or message may also indicate which users or groups of users are intended to receive the message, the time at which the message should be displayed, the duration for which it should be displayed, and other possible information.

In response to receiving messages or requests for messages from the input device 530, processor 525 generates one or more message packets as described above. Processor 525 may then pass the message packets to optional encoder 510. Encoder 510, if any, then encodes, multiplexes, and/or encrypts the message packets for transmission. For example, the message packets may be encoded into an appropriate network protocol and possibly encrypted. Further, several message packets may be multiplexed together for transmission over the transmission media. According to one embodiment of the present invention, processor 525 may perform the functions of encoder 510 rather than a separate encoder 510.

Encoder 510 or processor 525 then passes the encoded, multiplexed, and/or encrypted message packets to transmitter 505. Transmitter 505 may then modulate, amplify, or otherwise prepare or condition the message packets for transmission over whatever transmission media is being used for communication with the user systems. Transmitter 505 then transmits the message packets over the transmission media to one or more user systems.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

FIG. 6 is a flowchart illustrating providing messages to users of a message board system according to one embodiment of the present invention. In this example, operation begins with receive operation 605. Receive operation 605 comprises receiving one or more messages or requests for messages to be sent to users of the message display board service. As indicated above, the third-party advertiser or operator of the service provider system may enter, through a variety of input devices or over a network, a request for a message or an actual message to be transmitted to one or more of the users. The request or message may also indicate which users or groups of users are intended to receive the message, the time at which the message should be displayed, the duration for which it should be displayed, and other possible information. Operation then continues with determination operation 610.

Determination operation 610 comprises determining which users are intended to receive the message specified or requested by the third party advertiser. As indicated above, while some messages may be intended to be broadcast to all users, some messages may be intended for some subset of the users or even one specific user. Determining which user is to receive a given message may be based on a number of criteria. For example, information entered by the operator of the service provider system or the third party advertiser or from a database of information stored in the memory of the service provider system that relates a user or group of users to a particular message, type of message, advertiser, etc. Other similar criteria are also contemplated and considered to be within the scope of the present invention.

Next, operation continues with optional scheduling operation 615. Scheduling operation 615 can comprise scheduling a time for transmission of a message specified or requested by a third party advertiser to be made. Scheduling can be based on a number of criteria. For example, a transmission may be scheduled based on a time requested by the third party advertiser. Alternatively, scheduling may be based on a predetermined or even random time. In another alternative embodiment, scheduling may be based on the number of messages being handled by the service provider system and the bandwidth of the transmission media being used. Other similar criteria are also contemplated and considered to be within the scope of the present invention.

Generation operation 620 then generates one or more message packets to be transmitted to the user systems. As discussed above, the message packet can include an optional header and a message body. The header, if any, may include address information such as an IP address or other information identifying the user systems for which the message is intended as determined in determination operation 610. In other cases, the messages may be broadcast to all users, in such a case, the header may indicate an IP multicast address or other identifier. Alternatively, the header may include other information identifying the nature of the message such as a message type. According to one embodiment of the present invention, the header may also include information indicating a time and/or duration to be used by the user system in displaying the message. That is, rather than transmitting the message from the service provider system at a time determined in scheduling operation 615, information indicating a time and/or duration for the display as determined by scheduling operation 615 may be added to the header of each message packet. The message packet may then be transmitted from the service provider system as soon as possible. The individual user systems may then display the message at the time indicated in the header of the message. Generation operation 620 also includes placing text or other information indicating the message to be displayed into the message body of the message packet.

Operation then continues with encoding operation 625. Encoding operation 625 comprises encoding, encrypting, multiplexing, or otherwise preparing or conditioning the message packets for transmission to the user systems. That is, the message packets may be encoded into an appropriate network protocol and possibly encrypted. Further, several message packets may be multiplexed together for transmission over the transmission media.

Finally, control passes to transmission operation 625. Transmission operation 625 comprises transmitting the generated and encoded message packets to one or more user systems over the transmission media.

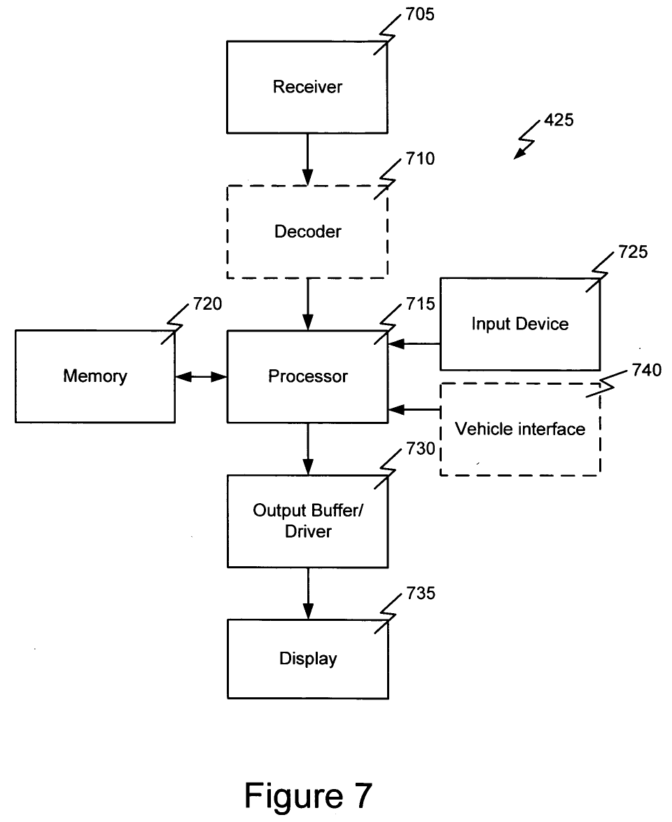

FIG. 7 is a block diagram illustrating a user system for displaying user designated messages and supervening, service provider originated messages according to one embodiment of the present invention. In this example, the user system 425 comprises a receiver 705 coupled with a decoder 710 which is in turn coupled with a processor 715. The processor 715 is also coupled with a memory 720 and one or more input devices 725. The processor may also be coupled with an optional vehicle interface 740 as well as an output buffer/driver for driving the display 735.

The processor 715 run programs, an example of which will be described in more detail below with reference to FIG. 8, that enable the user system to perform the tasks described thus far. Such programs may be stored in memory 720. Memory 720 may comprise a primary or secondary memory such as RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the user system 425 or other memory device located external to or within the user system. Memory 720 may also be internal to processor 715 in some embodiments.

The processor 715 can receive messages input to the system 425 via the input device 725. The input device 725 can be any one or combination of a variety of common input devices such as a keyboard, mouse, touchpad, voice recognition system, etc. For example, the input may be made through a keyboard into which the user types a message to be displayed. Alternatively, the message may be selected from a number of predetermined options stored in memory 720. For example, a user may use a numeric keypad, touchpad or other device to select a stored message to be displayed. According to one embodiment of the present invention, a message enter by the user through a keyboard may be stored in memory 720 for later retrieval and display.

For a user system placed in a motor vehicle, the processor 715 may also be coupled with an optional vehicle interface 740. The vehicle interface 740 may be coupled with the electrical system of the vehicle and detect various aspects of the operation of the vehicle. For example, the vehicle interface may detect the application of the vehicle's brakes or actuation of the vehicle's turn signals. In such a case, the vehicle interface 740 can send a signal to the processor 715 triggering the processor 715 to retrieve an appropriate, corresponding message from memory 720 for display.

Based on the input from the input device 725, the input from the vehicle interface 740, or based on some predetermined default message stored in memory 720 the processor can send a message to the output buffer/driver 730. The output buffer/driver can then use the message information from the processor to display the designated message on the display 735. Display 735 may be any of a variety of possible display types including but not limited to LED, LCD, CRT, etc.

The receiver 705 receives message packets transmitted from the service provider system over a transmission media as described above. The receiver 705 may demodulate, amplify, or otherwise condition the received signals for further processing by the rest of the user system 425. The receiver 705 may then pass the received message packets to optional decoder 710.

Decoder 710, if any, can decode, decrypt, demultiplex or otherwise process the message packets as appropriate. That is, since the service provider system may encode the message packets with a network protocol for transmission, the decoder 710 may be used to decode the message packets. Additionally, if the service provider system multiplexed and/or encrypted the message packets, decoder 710 may also demultiplex and decrypt the message packets. Alternatively, processor 715 can perform the functions of the decoder.

Processor 715 receives message packets from the decoder 710 or receiver 705 and reads the message packet header, if any, to determine whether the received message is intended for this user system. This determination may be based on an address or other identifying information as described above. In response to the received message being determined to be intended for the present user systems, the processor 715 can send message information as indicated in the body of the message packet to the output buffer/driver 730. The output buffer/driver can then use the message information from the processor to display the designated message on the display 735. Display 735 may be any of a variety of possible display types including but not limited to LED, LCD, CRT, etc. Alternatively, rather than immediately displaying the message, the header of the message packet may contain other information such as a time and/or duration for the message to be displayed. In such a case, the processor 715 can schedule the message to be displayed at the indicated time.

FIG. 8 is a flowchart illustrating displaying user designated messages and supervening, service provider originated messages according to one embodiment of the present invention. In this example, processing begins with query operation 805. Query operation 805 comprises determining whether a message packet has been received from the service provider. If a determination is made that a message packet has been received from the service provider, control passes to query operation 810.

Query operation 810 comprises determining whether the received message is intended to be displayed by the user system. That is, a determination is made as to whether the received message is intended for this or another user system. As discussed above, this determination may be based on a number of criteria but may comprise reading and analyzing the header information of the message packet. For example, the user system may check an address for an address such as an IP address or other information indicating the user system for which the message is intended. Alternatively, the message packet may include other identifying information such as a message type, user group, or other information identifying the user systems for which the message is intended. If a match is found between the identifying information of the message packet and the information stored in the user system memory, a determination is made that the message is intended to be displayed on this user system and the message is displayed in display operation 815. This message may remain displayed for a fixed, predetermined amount of time, a time indicated in the header information of the message packet, continuously until another message is received from the service provider or user or based on some other criteria.

If, at query operation 805, a determination that no message has been received from the service provider, control passes to query operation 820. Query operation 820 comprises determining whether a message has been input by the user. That is, a check is made to determine whether a user has typed selected or otherwise input a message to be displayed by the user system. If a determination is made that a message has been received from the user, the message will be displayed at display operation 825. This message may be displayed continually or for some predetermined amount of time. However, control also passes back to query operation 805 to determine whether a message packet has been received from the service provider. If one has, such a message may take precedence over the user message and supervene, i.e., be displayed in place of, the user's message.

If, at query operation 820, a determination is made that no message has been received from the user, control may pass to optional display operation 830. Display operation 830, if any, may comprise displaying a predetermined default message stored in the user system memory by the service provider or the user. Alternatively, the default message may be based on the operation of the vehicle indicated application of the brakes, turn signals, etc. If optional display operation 820 is omitted, the display may remain blank in the absence of a service provider message or user message.

The operations as outlined in FIG. 8 indicate one possible hierarchy or priority structure for displaying messages on the user system. As discussed above, other priority structures are also contemplated and considered to be within the spirit and scope of the present invention. For example, the priority level given to the different types of messages may depend upon the agreement between the user and the service provider with fees for the service dependent upon the priority given to the service provider messages. For example, a first fee level, which may be free, may require the user to accept all service provider messages at the highest priority with all other messages at a lower priority. Other, higher fee levels may be specified by the service provider to low for lowering the priority given to service provider messages.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A method of providing a low-cost message display board service comprising:
providing to each of a plurality of users of the message display board service a user system, the user system comprising a display board for displaying user designated messages and supervening, service provider generates messages;
receiving from one or more third party advertisers one or more requests for one or more messages to be sent to the user system;
determining one or more intended recipients of the plurality of users;
generating a message packet including a header indicating the one or more intended recipients and a message body including the message to be displayed;
encoding the message packet for transmission over a transmission media; and
transmitting the message packet to the user systems to be displayed on the display board of the user system of the one or more recipients in place of any user designated messages.

2. The method of claim 1, wherein receiving from one or more third party advertisers one or more requests for one or more messages to be sent to the user system comprises receiving text of a message to be displayed on the display board of one or more user systems.

3. The method of claim 1, further comprising determining a time at which the message should be displayed on one or more user systems.

4. The method of claim 3, further comprising transmitting the message packet to the user systems at the time at which the message should be displayed on one or more user systems.

5. The method of claim 3, further comprising adding to the header information indicating the time at which the message should be displayed on one or more user systems.

6. A method of displaying messages on a user system coupled with a message display board service provider comprising:
displaying on a display board of the user system a user designated message;
receiving from the service provider a message packet comprising a header containing information indicating intended recipients for the message and a message body containing information indicating a message to be displayed;
determining whether the user system is an intended recipient of the message packet based on the information indicating intended recipients from the header of the message packet; and
responsive to determining that the user system is an intended recipient of the message packet, reading the information indicating a message to be displayed from the message body and displaying the indicated message on the display board in place of the user designated message.

7. The method of claim 6, wherein determining whether the user system is an intended recipient of the message packet comprises determining whether the information indicating intended recipients from the header of the message packet indicates an address of the user system.

8. The method of claim 6, wherein determining whether the user system is an intended recipient of the message packet comprises determining whether the information indicating intended recipients from the header of the message packet indicates a user group of the user system.

9. The method of claim 6, wherein determining whether the user system is an intended recipient of the message packet comprises determining whether the information indicating intended recipients from the header of the message packet indicates a message type matching a predetermined message type to displayed by the user system.

10. The method of claim 6, wherein the header of the message packet also includes information indicating a time at which the message is to be displayed and further comprising reading the time at which the message is to be displayed and displaying the indicated message on the display board in place of the user designated message at the indicated time.

11. The method of claim 6, wherein the header of the message packet also includes information indicating a duration for which the message is to be displayed and further comprising reading the duration for which the message is to be displayed and displaying the indicated message on the display board in place of the user designated message for the indicated duration.

12. A method of providing a low-cost message display board system to users of a message display board service comprising:
supplying by a provider of a message display board service to one or more users display boards capable of displaying a user designated message;
allowing the users to display personalized messages designated by the user;
sending periodic, supervening messages from the service provider to the users display boards, the periodic supervening messages comprising advertising messages supplied by one or more third party advertisers who pay a fee to the service provider in exchange for the display of the messages; and
displaying on the display board the supervening messages from the service provider in place of any user designated message.

13. The method of claim 12, further comprising:
receiving from one or more third party advertisers one or more requests for one or more messages to be sent to the user system;
determining one or more intended recipients of the plurality of users;
generating a message packet including a header indicating the one or more intended recipients and a message body including the message to be displayed;
encoding the message packet for transmission over a transmission media; and
transmitting the message packet to the user systems to be displayed on the display board of the user system of the one or more recipients in place of any user designated messages.

14. The method of claim 12, wherein receiving from one or more third party advertisers one or more requests for one or more messages to be sent to the user system comprises receiving text of a message to be displayed on the display board of one or more user systems.

15. The method of claim 12, further comprising determining a time at which the message should be displayed on one or more user systems.

16. The method of claim 15, further comprising transmitting the message packet to the user systems at the time at which the message should be displayed on one or more user systems.

17. The method of claim 15, further comprising adding to the header information indicating the time at which the message should be displayed on one or more user systems.

18. The method of claim 12, further comprising:
displaying on a display board of the user system a user designated message;
receiving from the service provider a message packet comprising a header containing information indicating intended recipients for the message and a message body containing information indicating a message to be displayed;
determining whether the user system is an intended recipient of the message packet based on the information indicating intended recipients from the header of the message packet; and
responsive to determining that the user system is an intended recipient of the message packet, reading the information indicating a message to be displayed from the message body and displaying the indicated message on the display board in place of the user designated message.

19. The method of claim 6, wherein determining whether the user system is an intended recipient of the message packet comprises determining whether the information indicating intended recipients from the header of the message packet indicates an address of the user system.

20. The method of claim 6, wherein determining whether the user system is an intended recipient of the message packet comprises determining whether the information indicating intended recipients from the header of the message packet indicates a user group of the user system.
